(19) United States
(12) Patent Application Publication
(10) Pub. No.: US 2012/0268047 A1
(43) Pub. Date: Oct. 25, 2012

(54) FAN MOTOR DRIVING DEVICE, AND COOLING DEVICE AND ELECTRONIC MACHINE USING THE SAME

(75) Inventors: TOSHIYA SUZUKI, KYOTO (JP); NOBUO KOMURA, KYOTO (JP); SHINSUKE SANO, KYOTO (JP)

(73) Assignee: ROHM CO., LTD., KYOTO (JP)

(21) Appl. No.: 13/434,062

(22) Filed: Mar. 29, 2012

(30) Foreign Application Priority Data
Apr. 1, 2011 (JP) 2011-082082

(51) Int. Cl. H02P 6/16

(52) U.S. Cl. 318/400.04

(57) ABSTRACT

The objective of the present invention is to miniaturize a driving circuit of a fan motor. The present invention provides a driving device for driving a fan motor as a three-phase brushless DC motor. An inbuilt Hall component is disposed adjacent to the fan motor and generates a pair of Hall signals corresponding to a rotor position of the fan motor. An internal power source supplies a bias signal to the inbuilt Hall component. A Hall signal processing portion cancels a shift of the pair of Hall signals and amplifies the Hall signal. A driving processing circuit drives the fan motor according to an output signal of the Hall signal processing portion. The driving device is integrated on a semiconductor substrate.

### BACKGROUND OF THE INVENTION

1. Field of the Invention

The present invention relates to a motor driving technology.

2. Description of the Related Art

In order to cool a large scale integrated circuit (LSI), a cooling device having a fan motor is used. The cooling device includes a three-phase brushless DC (direct current) motor and a driving device for driving the three-phase brushless DC motor.

The driving method of the three-phase brushless DC motor is split into sensor driving and sensorless driving in substance. In sensor driving, a driving circuit uses a sensor such as a Hall component or an optical encoder to detect a rotor position, i.e. a rotation angle, and sequentially switches a phase (driving phase) of a supplying current according to the detected rotor position. In sensorless driving, a zero-crossing timing of a back electromotive force generated by each phase coil of the motor is detected for switching the driving phase sequentially.

Patent Document 1: Japanese Patent Publication No. 5-137379

Patent Document 2: Japanese Patent Publication No. 2008-022692

### SUMMARY OF THE INVENTION

### [Problems to be Solved by the Invention]

FIG. 1 is a block diagram of a cooling device having a sensor proposed by the present inventor. The cooling device 1004 includes a three-phase brushless DC motor (hereinafter referred to as motor) 6, a driving device 1100 of the driving fan motor 6, and three Hall components 8a-8c.

The Hall components 8a-8c are respectively disposed adjacent to the fan motor 6 and generate a pair of Hall signals (hereinafter referred to as Hall signal) H+, H− corresponding to a rotor position. A positional relation between the Hall components 8a-8c is meticulously adjusted in a manner enabling an electrical angle to become 120°.

The driving device 1100 includes a Hall signal detecting circuit 1010, a PWM (Pulse Width Modulation) signal generation circuit 1012, a driving signal synthesis circuit 1014, a driving circuit 1016, a rotation signal generation circuit 1020, and a power source 1022 for Hall component use.

The power source 1022 for Hall component use supplies a bias signal to the Hall components 8a-8c. The Hall signal detecting circuit 1010 receives three Hall signals and detects a timing for switching a driving phase according to the Hall signals. For example, the Hall signal detecting circuit 1010 may include a comparator which makes a comparison for the pair of Hall signals, and outputs an output signal of the comparator which is regarded as a signal denoting the timing for switching the driving phase. The Hall signal detecting circuit 1010 may also include an amplifier which performs a differential amplification for the pair of Hall signals. In this way, the driving circuit 1016 can perform a BTL (Bridged Transless) driving (linear driving) for the fan motor 6 according to an output of the amplifier.

The PWM signal generation circuit 1012 generates a pulse signal with a duty cycle corresponding to a target rotation speed of the fan motor 6. The driving signal synthesis circuit 1014 synthesizes the signals respectively from the Hall signal detecting circuit 1010 and the PWM signal generation circuit 1012 to generate a driving signal. The driving circuit 1016 drives the fan motor 6 according to the driving signal from the driving signal synthesis circuit 1014. The rotation signal generation circuit 1020 generates an effective rotation signal FG and outputs it to an outside while the rotor rotates a specific electrical angle every time,

The demands of miniaturizing and thinning the cooling device 1004 are raised increasingly. In the constitution shown in FIG. 1, the Hall components 8a-8c can stabilize the driving. On the contrary, a miniaturization of the cooling device 1004 will be limited by the thickness of the Hall components 8a-8c. Furthermore, a pin number (terminal number) of the driving device is requested to reduce. However, in the driving device 1100 shown in FIG. 1, many pins are required to receive the Hall signal, thereby limiting the miniaturization.

The present invention has been proposed under the circumstances described above. An objective of the present invention is to miniaturize a driving circuit of a fan motor.

### [Technical Means for Solving the Problems]

A driving device for driving a fan motor as a three-phase brushless DC motor according to an embodiment of the present invention includes: an inbuilt Hall component, disposed adjacent to the fan motor, for generating a pair of Hall signals corresponding to a rotor position of the fan motor; an internal power source, for supplying a bias signal to the inbuilt Hall component; a Hall signal processing portion, for canceling a shift of the pair of Hall signals and amplifying the Hall signal; and a driving processing circuit, for driving the fan motor according to an output signal of the Hall signal processing portion; wherein the driving device is integrated on a semiconductor substrate.

According to the above embodiment, a number of Hall components is reduced from three to one, and the Hall component is built into the driving device, thereby being capable of miniaturizing the device. Moreover, in a sensorless driving manner, a period before and after a zero-crossing timing and a detecting period in which the driving is stopped are required for detecting the zero-crossing timing. However, the driving device of the embodiment does not need to have the detecting period, thereby being capable of enhancing the driving efficiency.

An embodiment of the driving device further includes a phase adjusting circuit, which applies an adjustable delay to the Hall signal or a signal generated according to the Hall signal.

Since the Hall component is integrated with the driving device, a positional relation between the fan motor and the Hall component will be limited. In this way, a circumstance that the generated Hall signal does not denote a correct position of the rotor caused by an installed position of the driving device is obtained. By disposing the phase adjusting circuit, an adjustment can be performed in a manner enabling the Hall signal to denote the correct position of the rotor, thereby being capable of enabling the fan motor to rotate preferably.

The driving processing circuit may include: a driving timing generation portion, according to the output signal of the Hall signal processing portion, for generating a driving timing signal denoting a timing of switching a drive phase of the fan motor; and a driving circuit, for driving the fan motor according to the driving timing signal.

The driving processing circuit may further include: a driving PWM signal generation portion, for generating a pulse width modulation (PWM) signal with a time-dependent duty cycle according to the output signal of the Hall signal processing portion; and a driving signal synthesis circuit, for generating a driving signal by synthesizing the PWM signal and the driving timing signal. The driving circuit can perform a switching driving for the fan motor according to the driving signal.

The driving processing circuit can also perform a linear driving for the fan motor according to the output signal of the Hall signal processing portion.

Another embodiment of the present invention is a cooling device, which includes: a fan motor; and the driving device according to any of the above embodiments for driving the fan motor.

Moreover, an embodiment obtained from a mutual replacement between any combinations of the above constituent elements, the constituent elements of the present invention, and those exhibited in method, device, or system is also effective.

### [Effect of the Invention]

According to the present invention, a miniature, thinner cooling device having a fan motor can be realized.

### BRIEF DESCRIPTION OF THE DRAWINGS

FIG. 1 is a block diagram of a cooling device having a sensor proposed by the present inventor;

FIG. 2 is a block diagram of electronic machine including a cooling device according to a preferred embodiment of the present invention; and

FIG. 3 is a circuit diagram illustrating a driving device according to a variant embodiment.

### DETAILED DESCRIPTION OF THE INVENTION

The present invention based on the preferred embodiment is described below with reference to the accompanying drawings. The same or equal element, part, or process, contained in each of the accompanying drawings, will be denoted by a same symbol, and the repeat descriptions for them will be omitted suitably. Furthermore, the embodiment should not be limited to the illustrations of the invention. In other words, all of the features and the combinations thereof mentioned in the embodiment are not necessarily the same as the substantive features of the invention.

In the specification, so-called connection between part A and part B includes a directly connection between part A and part B in physically and an indirectly connection between part A and part B through other part that does not affect their electrically connection substantially or does not damage the performance or effect of their combination.

Similarly, so-called a state of part C disposing between part A and part B includes a directly connection between part A and part C or between part B and part C and an indirectly connection between them through other part that does not affect their electrically connection substantially or does not damage the performance or effect of their combination.

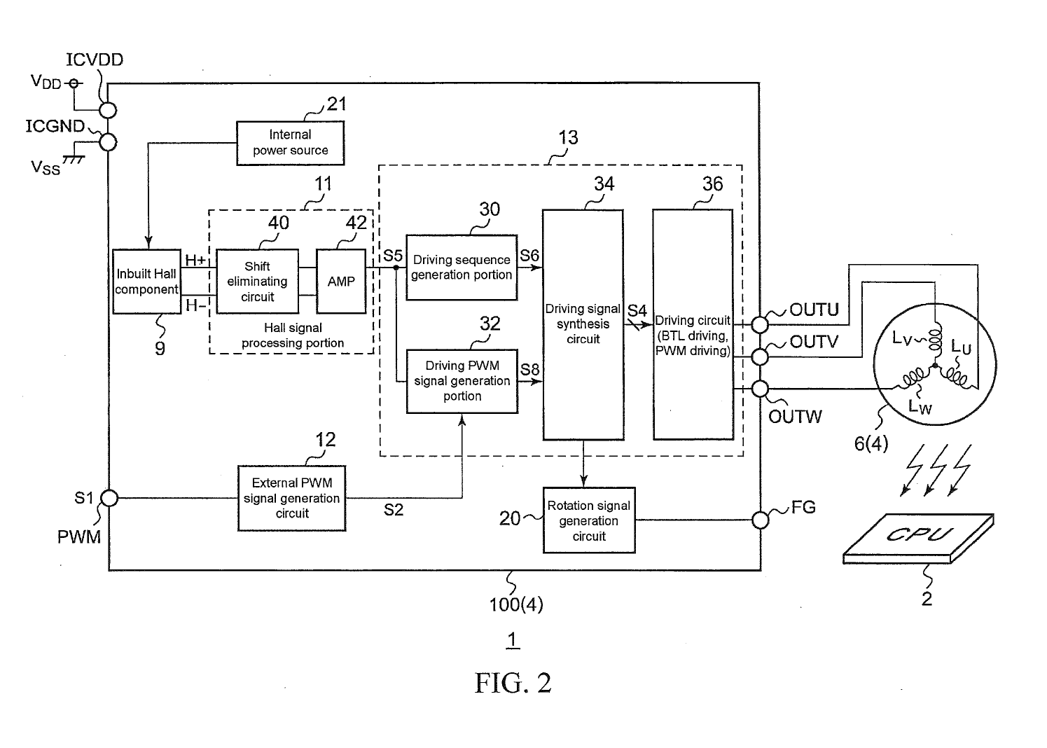

FIG. 2 is a block diagram of electronic machine 1 including a cooling device 4 according to a preferred embodiment of the present invention. The electronic machine 1 is a calculating machine such as personal computer or workstation, or a household appliance such as refrigerator or television, and includes a cooling target such as CPU (Central Processing Unit) 2. The cooling device 4 cools the CPU 2 via air blowing.

The cooling device 4 includes a driving device 100 and a fan motor 6. The fan motor 6 is disposed near the CPU 2 as the cooling target. The driving device 100 drives the fan motor 6 according to a control input signal (hereinafter referred to as control signal) Si used to indicate a torque (rotation speed) of the fan motor 6. The cooling device 4 is in sales and circulation after modularization.

The fan motor 6 is a three-phase brushless DC motor which includes a U-phase coil Lu, a V-phase coil L_{V}, a W-phase coil L_{W}, and a permanent magnet (not shown in the drawings), wherein the coils are in star connection.

The driving device 100 is a functional integrated circuit (IC) integrated on a semiconductor substrate. A power source voltage V_{DD} and a ground voltage V_{SS} are supplied to a power source terminal ICVDD and a ground terminal ICGND, respectively.

The driving device 100 includes an inbuilt Hall component 9, a Hall signal processing portion 11, an external PWM signal generation circuit 12, a driving processing circuit 13, a rotation signal generation circuit 20, and an internal power source 21, and is integrated on a semiconductor substrate.

The inbuilt Hall component 9 is integrated with the driving device 100 and generates a pair of Hall signals H+, H− corresponding to a rotor position of the fan motor 6. The internal power source 21 supplies a bias signal to the inbuilt Hall component 9.

The external PWM signal generation circuit 12 is an interface circuit for receiving an input signal S1. The input signal S1 from an outside is input to an input terminal PWM. In the present embodiment, the input signal S1 is a PWM signal which performs a pulse width modulation according to a target torque of the motor. Moreover, the input signal Si can be an analog voltage corresponding to an ambient temperature Ta obtained by using a thermistor, or a digital signal from a main processor as the CPU. The external PWM signal generation circuit 12 generates an external PWM signal S2 corresponding to the input signal S1. The external PWM signal S2 is a pulse width modulation signal with a duty cycle corresponding to the input signal S1.

The Hall signal processing portion 11 cancels a shift of the pair of Hall signals H+, H− in a shift canceling circuit 40, and amplifies the Hall signals H+, H− in an amplifier 42.

The driving processing circuit 13 drives the fan motor 6 according to the Hall signals H+, H− output from the Hall signal processing portion 11. In the present embodiment, the driving processing circuit 13 performs a PWM driving (switching driving) for the fan motor 6. An embodiment about the driving processing circuit 13 performs a BTL driving (linear driving) for the fan motor 6 will be described below.

The driving processing circuit 13 includes a driving timing generation portion 30, a driving PWM signal generation portion 32, a driving signal synthesis circuit 34, and a driving circuit 36.

The driving timing generation portion 30 receives a signal S5 output from the Hall signal processing portion 11, and generates a timing signal S6 denoting a crossing timing of the Hall signals H+, H− according to the signal S5.

The driving PWM signal generation portion 32 receives the output signal S5 of the Hall signal processing portion 11, and generates an internal PWM signal (S7, not shown in the drawings) with a time-dependent duty cycle according to the output signal S5. The duty cycle of the internal PWM signal S7 can vary in a manner of becoming minimal at a zero-crossing timing and becoming maximal in the vicinity of a midst between zero crossings. Consequently, a phase shift can be performed smoothly. Furthermore, the driving PWM signal generation portion 32 generates a driving PWM signal S8 by synthesizing the internal PWM signal S7 and the external PWM signal S2.

The driving processing circuit 13 receives the timing signal S6 and the driving PWM signal S8, and generates a driving signal S4 according to them. The driving circuit 36 supplies current to the coils L_{U}-L_{W} of the fan motor 6 according to the driving signal S4.

The rotation signal generation circuit 20 generates an effective rotation signal FG and outputs it to an outside while the rotor rotates a specific electrical angle every time.

The constitution of the driving device 100 has been described above, and its action is described below.

The control input signal Si denoting a target rotation speed of the fan motor 6 is provided for the driving device 100. The driving device 100 performs a specific starting timing to enable the fan motor 6 to start rotation from stopping. The Hall signals H+, H− corresponding to the rotor position are generated through the inbuilt Hall component 9 while the fan motor 6 starts to rotate.

The driving timing generation portion 30 detects a timing of switching the U-phase, the V-phase, and the W-phase according to the signal S5 corresponding to the Hall signals H+, H−. The driving signal synthesis circuit 34 and the driving circuit 36 sequentially select a coil to be electrified from the coils L_{U}, L_{V}, L_{W} and supply a driving current to the selected coil according to the detected timing.

The coil to be electrified is applied with a discontinuous driving voltage corresponding to the internal PWM signal S7 which performs a pulse width modulation according to the signal S5 output from the Hall signal processing portion 11. In this way, the current flowing through the coil varies slowly, thereby being capable of reducing noises and rotating efficiently.

Additionally, the coil to be electrified is applied with a discontinuous driving voltage corresponding to the external PWM signal S2 which performs a pulse width modulation according to the control input signal S1. Therefore, the torque (i.e. rotation speed) of the fan motor 6 can be controlled as a value corresponding to the control input signal S1.

The action of the cooling device 4 of the electronic machine 1 has been described above.

According to the driving device 100, a number of Hall components is reduced from three to one, and the Hall component is built into the driving device 100, thereby being capable of miniaturizing and thinning the device.

In order to miniaturize and thin the device, the other method as a sensorless driving manner has been proposed. However, in the sensorless driving manner, a period before and after a zero-crossing timing and a detecting period in which the driving is stopped are required for detecting the zero-crossing timing, thereby resulting in deterioration of the driving efficiency. On the contrary, the driving device 100 shown in FIG. 2 does not need to have the detecting period, thereby being capable of improving drawbacks of the sensorless driving manner and driving the fan motor 6 efficiently.

A variant embodiment is described below.

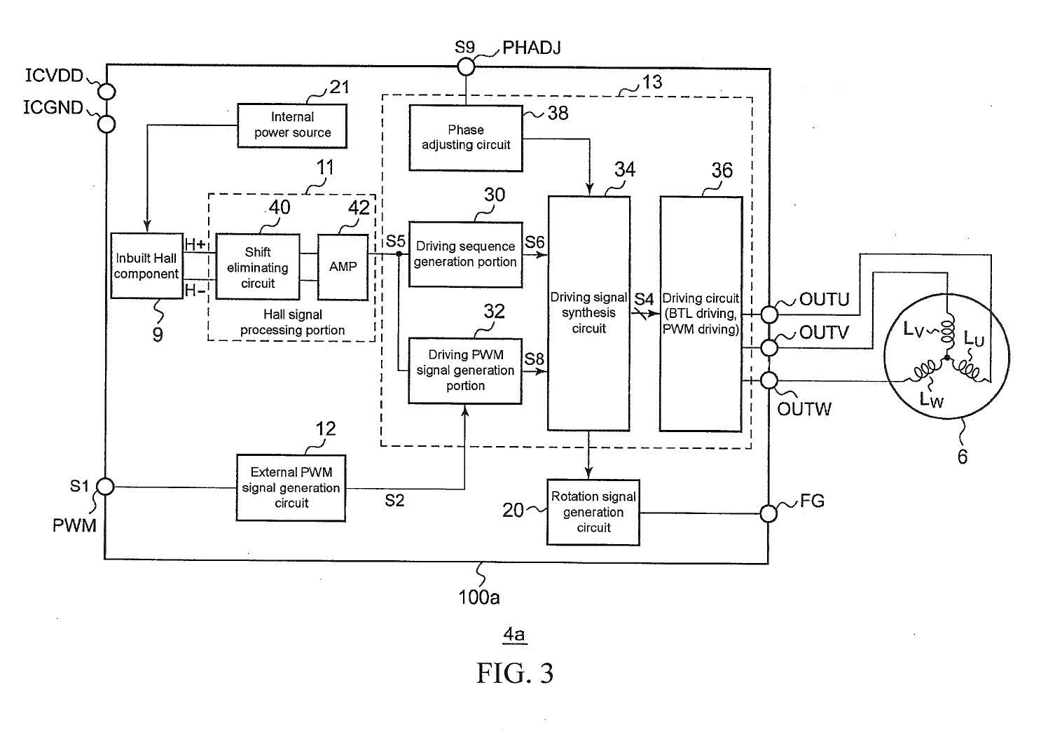

FIG. 3 is a circuit diagram illustrating a driving device 100a according to a variant embodiment. The driving device 100a shown in FIG. 3 further includes a phase adjusting circuit 38 in addition to the driving device 100 shown in FIG. 2.

The phase adjusting circuit 38 applies an adjustable delay to the Hall signals H+, H− output from the inbuilt Hall component 9, or the signal S5 generated according to the Hall signals, or the timing signal S6. The delay quantity can be controlled via a phase adjusting signal S9 which is input to a phase adjusting terminal PHADJ from an outside of the driving device 100a. Perhaps it can be adjusted automatically through the phase adjusting circuit 38 in a manner enabling the delay quantity to become a best value.

The phase adjusting circuit 38 can enable the signal processing of the driving signal synthesis circuit 34 to have a delay according to the set delay quantity. Probably, the phase adjusting circuit 38 can be disposed at a forepart of the Hall signal processing portion 11 to apply the delay to the Hall signals H+, H−, or disposed on a signal path of the Hall signal processing portion 11 to apply the delay to the signal S5. This means that the position of the phase adjusting circuit 38 does not need to be specially limited by means of a relative phase difference between the driving signal S4 and the rotor position can be changed.

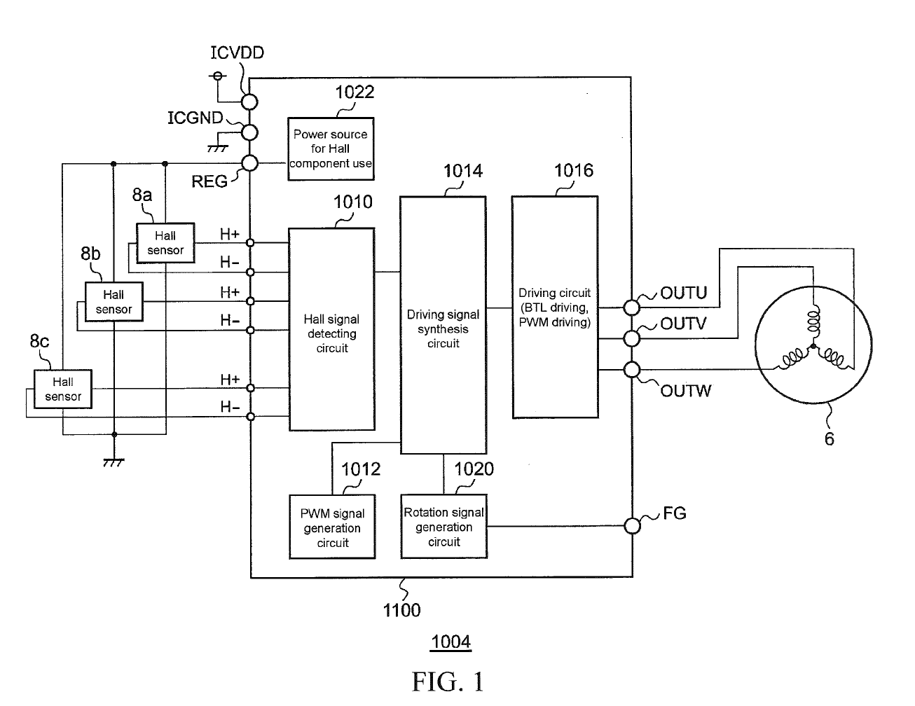

The cooling device 1004 shown in FIG. 1 has an outer Hall component 8, hence a positional relation between the fan motor 6 and the Hall component 8 can be adjusted freely. On the other hand, in the driving device 100 shown in FIG. 2, the Hall component is built into a semiconductor chip, hence a positional relation between the inbuilt Hall component 9 and the fan motor 6 will be limited by a positional relation between the driving device 100 and the fan motor 6. Consequently, a shift between a phase of the zero-crossing point denoted by the Hall signals H+, H− and the phase of a real zero-crossing point of the fan motor 6 may occur. Due to the phase shift, it is possible to have misgivings of reducing the driving efficiency of the fan motor 6 or enhancing the noise.

In the driving device 100a shown in FIG. 3, the positional relation between the fan motor 6 and the inbuilt Hall component 9 can be virtually changed through the phase adjusting circuit 38. In this way, a driving corresponding to a correct rotor position of the fan motor 6 can be realized.

In the above embodiment, a circumstance related to perform a PWM driving for the fan motor 6 has been described. However, the driving signal synthesis circuit 34 and the driving circuit 36 can also perform a linear driving for the fan motor 6. In this way, a driving waveform signal in synchronization with the Hall signals H+, H− is generated in the driving processing circuit 13, and the driving voltage applied to the coil of the fan motor 6 is changed according to the driving waveform signal.

In the embodiment, although the circumstances about the cooling device 4 being installed in the electronic machine to cool the CPU has been described, the present invention should not be limited to the above use. The other use for cooling a heat generation body is allowable.

While several embodiments of the present invention have been illustrated and described, various modifications and improvements can be made by those skilled in the art. The embodiments of the present invention are therefore described in an illustrative but not in a restrictive sense. It is intended that the present invention should not be limited to the particular forms as illustrated and that all modifications which maintain the spirit and scope of the present invention are within the scope defined in the appended claims.

What is claimed is:

1. A driving device for driving a fan motor as a three-phase brushless DC motor, comprising:
one inbuilt Hall component, disposed adjacent to the fan motor, for generating a pair of Hall signals corresponding to a rotor position of the fan motor;
an internal power source, for supplying a bias signal to the inbuilt Hall component;
a Hall signal processing portion, for canceling a shift of the pair of Hall signals and amplifying the Hall signal; and
a driving processing circuit, for driving the fan motor according to an output signal of the Hall signal processing portion;
wherein the driving device is integrated on one semiconductor substrate.

2. The driving device as claimed in claim 1, further comprising a phase adjusting circuit, which applies an adjustable delay to the Hall signal or a signal generated according to the Hall signal.

3. The driving device as claimed in claim 1, wherein the driving processing circuit comprises:
a driving timing generation portion, according to the output signal of the Hall signal processing portion, for generating a driving timing signal denoting a timing of switching a drive phase of the fan motor; and
a driving circuit, for driving the fan motor according to the driving timing signal.

4. The driving device as claimed in claim 2, wherein the driving processing circuit comprises:
a driving timing generation portion, according to the output signal of the Hall signal processing portion, for generating a driving timing signal denoting a timing of switching a drive phase of the fan motor; and
a driving circuit, for driving the fan motor according to the driving timing signal.

5. The driving device as claimed in claim 3, wherein the driving processing circuit comprises:
a driving PWM signal generation portion, for generating a pulse width modulation (PWM) signal with a time-dependent duty cycle according to the output signal of the Hall signal processing portion; and
a driving signal synthesis circuit, for generating a driving signal by synthesizing the PWM signal and the driving timing signal;
wherein the driving circuit performs a switching driving for the fan motor according to the driving signal.

6. The driving device as claimed in claim 4, wherein the driving processing circuit comprises:
a driving PWM signal generation portion, for generating a pulse width modulation (PWM) signal with a time-dependent duty cycle according to the output signal of the Hall signal processing portion; and
a driving signal synthesis circuit, for generating a driving signal by synthesizing the PWM signal and the driving timing signal;
wherein the driving circuit performs a switching driving for the fan motor according to the driving signal.

7. The driving device as claimed in claim 1, wherein the driving processing circuit performs a linear driving for the fan motor according to the output signal of the Hall signal processing portion.

8. The driving device as claimed in claim 2, wherein the driving processing circuit performs a linear driving for the fan motor according to the output signal of the Hall signal processing portion.

9. A cooling device, comprising:
a fan motor; and
the driving device according to claim 1 for driving the fan motor.

10. An electronic machine, comprising:
a processor; and
the cooling device according to claim 9 for cooling the processor.
